(19) United States
(12) Patent Application Publication
(10) Pub. No.: US 2009/0138292 A1
(43) Pub. Date: May 28, 2009

(54) DRIVING SOFTWARE PRODUCT CHANGES BASED ON USAGE PATTERNS GATHERED FROM USERS OF PREVIOUS PRODUCT RELEASES

(75) Inventors: JAGANNADHARAO V. DUSI, POUGHKEEPSIE, NY (US); SHANNON P. HARDT, AUSTIN, TX (US); MARK D. KROL, STORMVILLE, NY (US); SHIJU MATHAI, CARROLLTON, TX (US)

Correspondence Address: PATENTS ON DEMAND, P.A. - IBM CHA, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 11/944,752

(22) Filed: Nov. 26, 2007

(51) Int. Cl. G06Q 10/00

(52) U.S. Cl. 705/7

(57) ABSTRACT

The present invention discloses an end-to-end software development system that includes multiple computing devices, a network data store, and a usage reporting engine. Each of the computing devices can execute a software product that is configured to automatically log usage information on a feature-by-feature basis. The network data store can aggregate logged usage information obtained from the computing devices. The usage report engine can analyze data of the network data store and can generate feature-by-feature usage reports. These reports can be used to focus a software development effort on user desired features and/or upon previous software product shortcomings.

### BACKGROUND

1. Field of the Invention

The present invention relates to the field of software development and, more particularly, to software product changes based on usage patterns gathered from users of previous product releases.

2. Description of the Related Art

A majority of successful software products are modified in a series of iterative version releases. New versions provide new desired features, integrate new technologies into an existing product, and generally correct perceived shortcomings of previous releases. A success of a new version of a software product can ultimately be determined by a user population and whether this population utilizes and is satisfied by the new features/changes made in the new version of the software product.

Several conventional factors drive the evolution of a software product such as competition, market opportunities, and user feedback. User feedback is a pivotal factor and can be obtained in the form of surveys and usability studies. These forms of user feedback are important to the software industry as evidenced by their widespread use. Traditional feedback forms have a number of significant limitations, such as response biases.

Additionally, survey instruments, incentivized feedback, usage studies, and other product success determination techniques are expensive and time consuming to implement. Traditional methods include user surveys and usability testing, which are limited in scope. At present, conventional software evolution is based on a set of educated guesses regarding what end-users desire and a series of additional guesses regarding whether new features are actually being utilized and valued by end users. So while user insight and feedback is important to the software requirement management process, it is often an incomplete and one dimensional source of information. It would be advantageous if automated real-time usage patterns, generated directly from the real-time usage of an application, could be integrated into the software development cycle to aid in creating more successful software revisions that can be successfully adopted and effectively used by end users. It would also be beneficial if feature enhancement usage was tracked by development tools against expected end user usage patterns to systematically determine feature success.

### SUMMARY OF THE INVENTION

The present invention discloses a solution for directing software evolution based upon real time usage patterns of previous product releases. In the solution, usage patterns obtained from a software application's user population can be used to direct the requirements management process. This solution can be used in parallel to current development techniques increasing the correlation between software evolution and user needs. Effectively, the disclosed solution adds a “sense and respond” capability to the software design process, where software developers are granted insights into useful features, usability issues, training needs, and other concerns about a software product. These insights can be gleaned from reports showing how a previous release of a product is actually used in a production environment on a feature-by-feature basis.

More specifically, usage patterns can be recorded and conveyed to a central repository. For example, feature use, frequency, and duration can be monitored from the actual production environment as a software product is used. In one embodiment, user specific metrics, such as expertise level or authority level can be monitored and mapped to specific software feature usage. Usage data can be aggregated in a central repository for data mining. Data mining can allow for the production of usage pattern reports, which can give rise to meaningful relationships between user activity and software features. Generated reports can be used to present correlations between requirements management and software features. These correlations can be useful in project planning, task management, execution faults, and feature development prioritization.

It should be noted that various embodiments of the invention can be implemented as a program for controlling computing equipment to implement the functions described herein, or as a program for enabling computing equipment to perform processes corresponding to the steps disclosed herein. This program may be provided by storing the program in a magnetic disk, an optical disk, a semiconductor memory, any other recording medium, or can also be provided as a digitally encoded signal conveyed via a carrier wave. The described program can be a single program or can be implemented as multiple subprograms, each of which interact within a single computing device or interact in a distributed fashion across a network space.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram illustrating a system in which software is developed as part of an end-to-end iterative solution in which software changes are driven by actual software usage information.

FIG. 2 is a sample report showing actual usage of a Top N number of features verses expected use.

FIG. 3 is a sample report showing actual usage of software features by department.

FIG. 4 is a sample report showing software feature use by country.

FIG. 5 is a flow chart illustrating a method for driving software changes based on usage patterns gathered from users of previous releases in accordance with an embodiment of inventive arrangements disclosed herein.

### DETAILED DESCRIPTION OF THE INVENTION

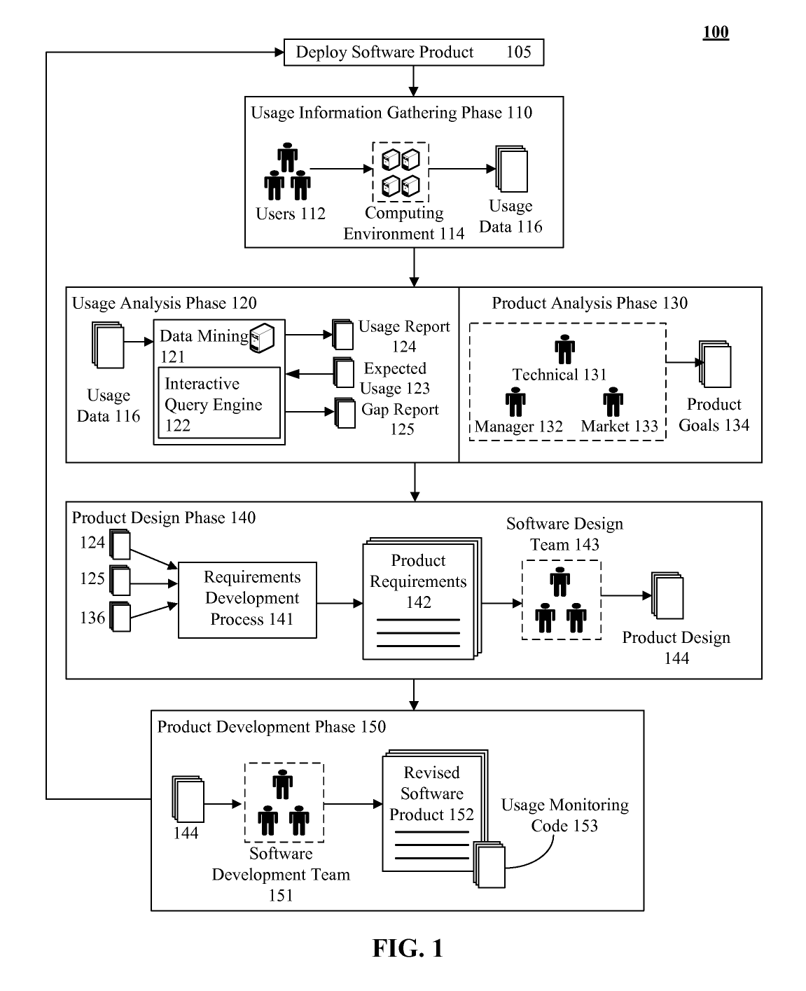

FIG. 1 is a schematic diagram illustrating a system 100 in which software is developed as part of an end-to-end iterative solution in which software changes are driven by actual software use. Effectively, system 100 integrates a novel “sense and respond” capability to the software design process, where information concerning feature-by-feature use of a deployed software product is used for developing new product versions. Thus, production usage feedback is integrated into the software development cycle to aid in creating more successful software revisions that can be successfully adopted and effectively used by end users.

System 100 shows a number of distinct software design phases, which include a deployment phase 105, a usage information gathering phase 110, an analysis phase 120 and 130, a product design phase 140, and a product development phase 150. Each phase can include generated documents useful in guiding the software development process. Software revisions, enhancements, and new features can be driven by usage data obtained from users 112 of previous versions of the software product. A software revision can include the addition of new features, program error fixes, graphical user interface (GUI) usability improvements and the like.

Initially, a software product 105 can be deployed in a manner in which usage of the product can be monitored. In one embodiment, usage monitoring code 153 can be directly inserted in the software product 105. In another embodiment, an executing program can be distinctly implemented from a usage monitoring component. Regardless, usage of deployed software 105 can be recorded, as shown by phase 110. Each software product can be used by multiple users 112. In one embodiment, the usage data 116 can detail many user 112 specific attributes, which can be used to customize usage reports 124. User 112 specific attributes can include, but are not limited to, a user's proficiency level, organization, role in an organization, authority level within the organization, physical location, and the like.

In one embodiment, a user identifier can initially be included in a locally generated usage log. Personnel and other data stores can be accessed to determine user specific attributes for the user by querying these databases using the user identifier as a unique key. When privacy, confidentiality, and/or security are a concern, usage data 116 can be sanitized before being sent to a remote data repository. Sanitizing data is a process through which personal identifying elements are removed to produce accurate, but impersonal usage records. The user 112 specific usage records can be important to track whether different types of users 112 are utilizing software features than those whom the software design team 143 or other feature defining agents (131-133) envisioned.

The usage data 116 can also include information concerning the machines 114 upon which the deployed software product 105 executes. Machine specific data can include available hardware resources, operating system, other software applications executing on the machines, response time, etc. Hardware specific information relating to the computing environment 114 can help designers determine whether certain software features of a product 105 are more successful on one platform compared to another, whether a specific feature is used more often when response time is over a particular threshold, whether some features that are otherwise popular are ignored when competing software is present on a machine upon which the product 105 executes, and the like.

In general, the usage data 116 will include an interaction log that includes for each interaction, a timestamp, a unique user identifier, and a unique application feature used. The timestamp can be used to determine a duration of feature usage and an order of usage among different features. The usage data 116 can be used, for example, to record an order in which different features are executed relative to each other. These feature usage sequences can be significant when determining usage patterns which can impact future designs of the product. For example, if two current features require multiple interface steps to utilize, yet which are still used very often in sequence, then future design teams 143 can decide to decrease the number of steps a user must perform to use the features in sequence.

An analysis phase can include a product analysis phase 130 and a usage analysis phase 120. In the product analysis phase 130 a set of product goals 134 can be established by managers 132, marketing personnel 133, and technical consultants 131. These goals can indicate which markets a new software version is to attempt to penetrate, usage goals for new features, and the like.

The usage analysis phase 120 can utilize aggregated usage data 116 obtained in the information gathering phase 110. The aggregated usage data 116 can be data-mined 121 or can be interactively queried 122 to produce usage reports 124. Further, expected usage reports 123, developed from past development cycle product goals 134 can be compared against the usage data 116 to produce gap reports 125. Gap reports 125 express deltas between expected feature usage and actual feature usages by users 112 in a production environment.

The usage reports 124, gap reports 125, expected usage reports 123, and other reports 136 (e.g., user survey reports, usability testing reports, etc.) can be examined during the requirements development process 141 by experts to generate a set of product requirements 142. These product requirements 142 can be optionally refined by a software design team 143 until a set of product design documents 144 are produced. These documents 144 can be conveyed to a software development team 151, which uses them to produce a revised software product 152 in a product development phase 150. In one embodiment, the revised product 152 can include usage monitoring code 153. The code 153 can also be a separate application bundled with the product 152, which is to be executed when the revised software product 152 is deployed (105) into a runtime environment (110).

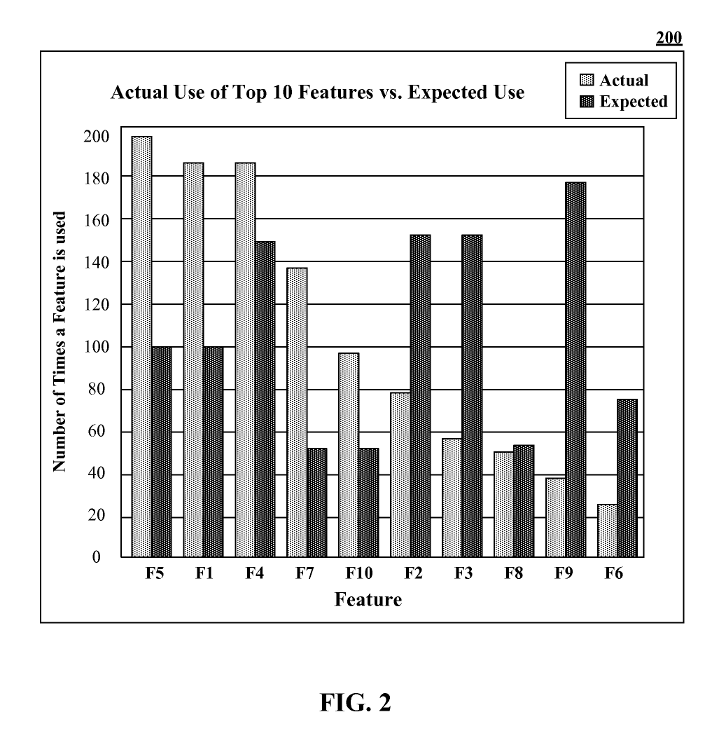

FIG. 2 is a sample report 200 showing actual usage of a Top N number of features verses expected use. The report 200 can be generated in the context of system 100 and represents one contemplated variant of a gap report 125.

Report 200 shows a bar chart of actual verses expected usages across ten features, F1-F10, in order of decreasing actual usages. As shown, Feature 5 (e.g., F5) received approximately one hundred and ninety seven usages, while a number of expected usages was one hundred. Thus, report 200 indicates that Feature 5 was successfully implemented in a software product and was well received by users. In contrast, the number of actual usages for Feature 2 was approximately seventy nine while the number of expected usages was approximately one hundred and fifty. The shortfall of actual usages against expected usages for Feature 2 can indicate that users may not have been aware of an existence of Feature 2, that users may not have liked the implementation of Feature 2, that users may not desire functionality of Feature 2 as much as believed, and the like. Analysts can combine results shown in report 200 with other feedback artifacts, such as user survey results, to interpret a meaning of the report 200.

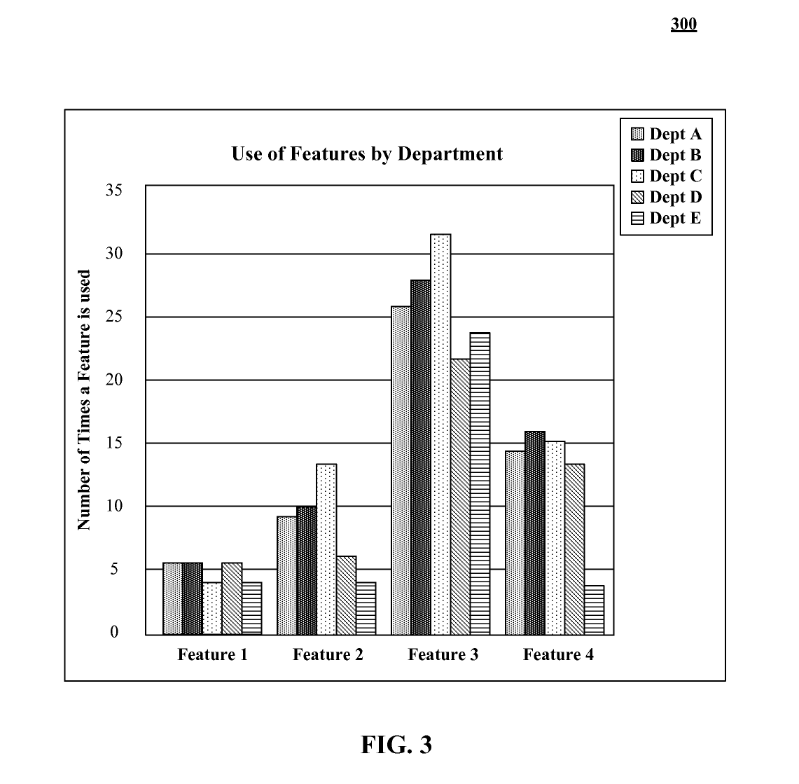

FIG. 3 is a sample report 300 showing actual usage of software features by department. The report 300 can be generated in the context of system 100 and represents one contemplated variant of a usage report 124.

Report 300 shows the number of times that four different features, Features one through four, are used by five different departments, Departments A-E. For example, the report 300 shows that Feature 1 was used six times by Department A, six times by Department B, Four times by Department C, six times by Department D, and four times by Department E.

It should be appreciated that different departments can have different associated areas of responsibility and reports like report 300 can help software designers target different functional markets. Report 300 can also help software designers bundle and price different subsets of features of a single software product in a manner designed to maximize profits. For example, a feature report 300 can show that one feature is highly used by enterprise-level users, but is rarely used by others, which could indicate that the feature should be bundled only with an enterprise product.

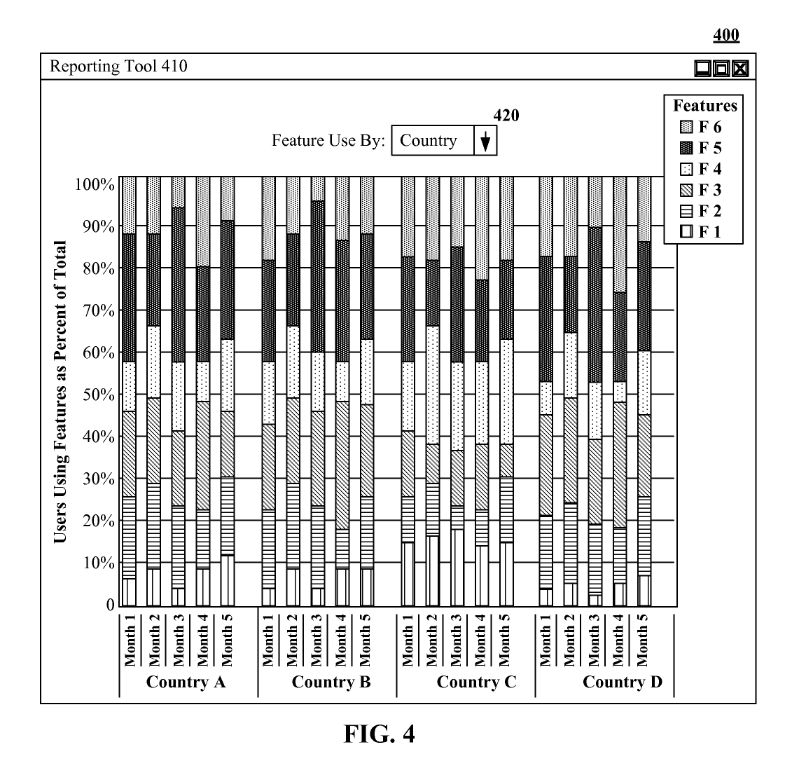

FIG. 4 is a sample report 400 showing feature use by country. The report 400 can be generated in the context of system 100 and represents one contemplated variant of a usage report 124.

Report 400 shows a usage of each of six features, F1-F6, as a percentage of total usage by country and month. For example as shown, Country A in Month 1 had usage percentages of approximately six percent (of total usage percent) for Feature 1, nineteen percent for Feature 2, twenty one percent for Feature 3, nine percent for Feature 4, thirty two percent for Feature 5, and thirteen percent for Feature 6.

The report 400 is one report that a reporting interface 410 is able to dynamically generate. Similar feature usage reports illustrating usage by organization, by role, and the like can be presented by changing a parameter of interface selector 420.

Reports 200, 300, and 400 are for illustrative purposes only and are not to be construed to limit the invention in any way. That is, report 200, 300, 400 or interface arrangements expressed in FIGS. 2-4 are not intended to exhaustively illustrate contemplated arrangements, which will naturally vary based upon implementation specifics for which the solution is used.

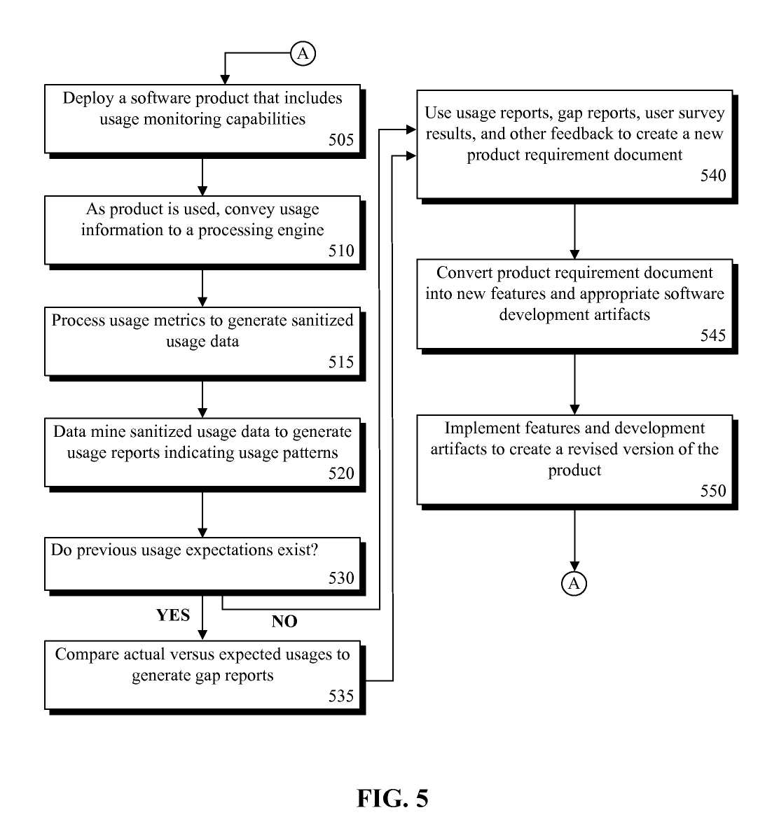

FIG. 5 is a flow chart illustrating a method 500 for driving software changes based on usage patterns gathered from users of previous releases in accordance with an embodiment of inventive arrangements disclosed herein. Method 500 can be performed in the context of system 100. Method 500 illustrates a process of utilizing automatically gathered usage data to generate reports useful in developing software products consistent with a user centric focus.

In step 505, a software product can be deployed that has product usages recorded by a usage monitoring component. The monitoring component can be internally coded or can be an external software component which can optionally be bundled with the software when it is deployed. As the product is used, usage monitoring capabilities can convey usage information to a processing engine, as shown in step 510. In step 515, the processing engine can process usage metrics to generate sanitized usage data. Sanitized data can include a data set wherein specific personally identifiable information is removed. The removal of this information can satisfy privacy requirements necessary in keeping a data set untainted. In step 520, an engine can data mine sanitized usage data to generate reports indicating usage patterns.

In determining step 530, if previous expected usages exist then the method can proceed to step 535. Otherwise, the method can proceed to step 540. In step 535, expected usages can be compared against actual usages to generate one or more gap reports. Usage reports, gap reports, and expected usage reports can be used to generate a new product requirement document, as shown in step 540. In step 545, a product requirement document can be converted into new features and software development artifacts that include the new features. In step 550, features can be implemented and the development artifacts can be used to create a revision version of the product.

The present invention may be realized in hardware, software, or a combination of hardware and software. The present invention may be realized in a centralized fashion in one computer system or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

What is claimed is:

1. A software development tool comprising:
usage report generating software module stored in a machine readable medium executable by a machine to cause the machine to create customizable reports of a usage of a deployed software product, wherein usage information that drives the reports produced by the usage report generating software module are gathered from a plurality of different computing devices that run the deployed software product and a plurality of different end-users that utilize the deployed software product, wherein the report generating software module is configured to report usage on a feature-by-feature basis.

2. The tool of claim 1, wherein the usage report generating software module is part of a suite of software development tools used to manage software development efforts for versioned software.

3. The tool of claim 1, wherein at least one of the customizable reports compares actual usages of various features against expected usages established during a software development phase of the deployed software product.

4. The tool of claim 1, wherein at least one of the customizable reports is a feature-by-feature usage report designed to be used to guide software development efforts and to determine changes to be introduced in subsequent versions of the software product based on actual product usage metrics.

5. The tool of claim 1, wherein details of at least one of the reports shows actual feature usages by an organization specific attribute.

6. The tool of claim 1, wherein at least one of the reports shows a feature usage as a percentage of total feature usage.

7. The tool of claim 6, wherein at least one of the reports permits the feature usage to be analyzed by at least one of a location, an organization, and a user role.

8. An end-to-end software development system comprising:
a plurality of computing devices, each executing a software product that is configured to automatically log usage information on a feature-by-feature basis;
a network data store configured to aggregate logged usage information from the plurality of computing devices; and
a usage report engine configured to analyze data of the network data store and to generate feature-by-feature usage reports.

9. The system of claim 8, wherein the feature-by-feature usage reports are used to guide software development efforts and to determine changes to be introduced in subsequent versions of the software product based on actual product usage metrics.

10. The system of claim 8, wherein the analyzed data of the network data store is maintained in a database, wherein at least a portion of the feature-by-feature usage reports are customizable reports based upon structured query language (SQL) queries of the database.

11. The system of claim 8, wherein details of at least one of the reports are summarized based upon a plurality of user attributes of users utilizing the computing devices, wherein the logged usage information includes information related to the user attributes.

12. The system of claim 8, wherein at least one of the usage reports indicates sequential usage patterns among features of the software product.

13. The system of claim 12, wherein at least one of the usage reports compares actual usages of various features against expected usages of those features established during a software development phase of the software product.

14. A method for utilizing usage patterns to drive software development efforts comprising:
deploying software that includes usage monitoring code;
executing the deployed software in a runtime environment on a computing device;
conveying usage data from the computing device to a remotely located data store;
analyzing the data in the data store to generate a usage report for the deployed software, wherein said usage report indicates usage patterns; and
generating at least one feature-by-feature gap report based upon comparisons between the usage data and expected usage data, wherein the usage report and the gap report are utilized during a software development process to determine changes that are to be made in a next version of the deployed software.

15. The method of claim 14, further comprising:
for a series of consecutive software releases, repeating the deploying, executing, conveying, analyzing, and generating steps.

16. The method of claim 14, wherein a data mining software application and an interactive query software application are used to generate the usage report and the gap report based at least in part upon the usage data.

17. The method of claim 14, further comprising:
wherein results of the analyzing step are stored in a database, wherein at least a portion of the usage reports and the gap reports are customizable reports based upon structured query language (SQL) queries of the database.

18. The method of claim 14, further comprising:
separating an end-to-end software product development effort into a series of phases, which include a software deployment phase, a usage information gathering phase, an analysis phase, a product design phase, and a product development phase, wherein the deploying step occurs during the deployment phase, wherein the executing and conveying steps occur during the usage information gathering phase, wherein the analyzing and generating steps are performed in the analysis phase, the usage report and the gap report are used during product design phase to create a product design document, which is used during the product development phase to create the next version of the deployed software.

19. The method of claim 14, further comprising:
providing a software development tool that manages an end-to-end product development effort, which automatically generates the usage reports and the gap reports from the usage data.

20. The method of claim 14, wherein said conveying, analyzing, and generating steps are performed by at least one machine in accordance with at least one computer program stored in a computer readable media, said computer programming having a plurality of code sections that are executable by at least one machine.
